(19) United States
(12) Patent Application Publication
(10) Pub. No.: US 2015/0301074 A1
(43) Pub. Date: Oct. 22, 2015

(54) PHYSICAL QUANTITY DETECTING CIRCUIT, PHYSICAL QUANTITY DETECTION DEVICE, PHYSICAL QUANTITY MEASUREMENT SYSTEM, ELECTRONIC APPARATUS, MOVING OBJECT, AND PHYSICAL QUANTITY MEASUREMENT DATA GENERATION METHOD

(71) Applicant: Seiko Epson Corporation, Tokyo (JP)

(72) Inventors: Takemi YONEZAWA, Minowa (JP); Toshiyuki NOZAWA, Okaya (JP)

(21) Appl. No.: 14/684,643

(22) Filed: Apr. 13, 2015

(30) Foreign Application Priority Data
Apr. 17, 2014 (JP) 2014-085775

(51) Int. Cl. G01P 15/02

(52) U.S. Cl. CPC G01P 15/02

(57) ABSTRACT

A physical quantity detecting circuit includes a detection signal generation section adapted to generate a detection signal corresponding to a physical quantity at a first rate based on an output signal of an inertial sensor, an arithmetic processing section adapted to perform arithmetic processing based on the detection signal, a measurement data holding section adapted to hold measurement data based on the detection signal, and a measurement completion flag generation section adapted to generate and then output a measurement completion flag at a second rate lower than the first rate.

### BACKGROUND

1. Technical Field

The present invention relates to a physical quantity detecting circuit, a physical quantity detection device, a physical quantity measurement system, an electronic apparatus, a moving object, and a physical quantity measurement data generation method.

2. Related Art

There have been developed physical quantity detection devices for detecting a physical quantity such as acceleration or an angular velocity using an inertial sensor.

JP-A-10-282136 discloses an acceleration sensor for outputting an output of a single sensor element after performing two filter treatments, which are different from each other, on the output of the sensor element for respective purposes.

JP-A-2012-168096 discloses a physical quantity sensor, which reduces the number of times of the filter operation based on sampling values output from an A/D converter to thereby reduce the power consumption.

In the case of using the measurement data of the physical quantity due to the inertial sensor for a plurality of purposes, it is common to generate the measurement data in accordance with the purpose in which the sampling at the highest rate is required. However, even in the purpose in which the sampling at the highest rate is not required, there is required the necessity of reading the measurement data in accordance with the highest rate, and therefore, there is a problem that the power consumption as a whole system is high.

### SUMMARY

An advantage of some aspects of the invention is to provide a physical quantity detecting circuit, a physical quantity detection device, a physical quantity measurement system, an electronic apparatus, a moving object, and a physical quantity measurement data generation method each capable of reducing the power consumption as a whole system.

The invention can be implemented as the following forms or application examples.

### Application Example 1

A physical quantity detecting circuit according to this application example includes a detection signal generation section adapted to generate a detection signal corresponding to a physical quantity at a first rate based on an output signal of an inertial sensor, an arithmetic processing section adapted to perform arithmetic processing based on the detection signal, a measurement data holding section adapted to hold measurement data based on the detection signal, and a measurement completion flag generation section adapted to generate and then output a measurement completion flag at a second rate lower than the first rate.

According to this application example, since the measurement completion flag is generated at the second rate lower than the first rate of the detection signal, the measurement data can externally be read out based on the measurement completion flag. Therefore, since the frequency of reading out the measurement data can be reduced compared to the case of reading out the measurement data at the first rate, the physical quantity detecting circuit capable of reducing the power consumption as the whole system can be realized. Further, since the detection signal at the first rate higher than the second rate can be used in the arithmetic processing of the arithmetic processing section, the arithmetic processing high in accuracy becomes possible.

### Application Example 2

In the physical quantity detecting circuit described above, the measurement completion flag generation section may include a counter adapted to perform counting at the first rate, and output the measurement completion flag when the counter reaches a set value.

According to this configuration, the measurement completion flag can be output at the second rate lower than the first rate.

### Application Example 3

In the physical quantity detecting circuit described above, the measurement data holding section may update the measurement data to be held in sync with the measurement completion flag.

According to this configuration, since the amount of the measurement data externally read out can be reduced, the physical quantity detecting circuit capable of reducing the power consumption as the whole system can be realized.

### Application Example 4

In the physical quantity detecting circuit described above, the physical quantity detecting circuit may further include a measurement data storage section adapted to store the measurement data, which is held by the measurement data holding section, sequentially up to a set number, the measurement data holding section may hold the measurement data at the second rate, and the measurement completion flag generation section may generate and then output the measurement completion flag in a case in which the measurement data holding section has stored the measurement data up to the set number.

According to this application example, since the frequency of reading out the measurement data can be reduced compared to the case of reading out the measurement data at the first rate, the physical quantity detecting circuit capable of reducing the power consumption as the whole system can be realized.

### Application Example 5

In the physical quantity detecting circuit described above, the physical quantity detecting circuit may further include a counter adapted to perform counting at the first rate, and the measurement data storage section may update the measurement data to be stored in sync with a timing at which the counter reaches a set value.

According to this configuration, since the amount of the measurement data externally read out can be reduced, the physical quantity detecting circuit capable of reducing the power consumption as the whole system can be realized.

### Application Example 6

In the physical quantity detecting circuit described above, the physical quantity detecting circuit may further include a filter disposed between the detection signal generation section and the measurement data holding section.

According to this configuration, the filter treatment suitable for the measurement data to be held by the measurement data holding section can be performed independently of the arithmetic processing section.

### Application Example 7

In the physical quantity detecting circuit described above, the arithmetic processing may be a tap detection processing adapted to detect one of presence and absence of a tap input.

According to this configuration, since it is sufficient to read out at the acceleration measurement data rate of a necessary data rate in the case of performing the tap detection processing and the case of performing the normal acceleration measurement data acquisition, the physical quantity detecting circuit capable of reducing the power consumption as the whole system can be realized.

### Application Example 8

A physical quantity detection device according to this application example includes any one of the physical quantity detecting circuits described above, and the inertial sensor.

### Application Example 9

A physical quantity measurement system according to this application example includes the physical quantity detection device described above, and an arithmetic processing device adapted to read out the measurement data based on the measurement completion flag.

### Application Example 10

An electronic apparatus according to this application example includes any one of the physical quantity detecting circuits described above.

### Application Example 11

A moving object according to this application example includes any one of the physical quantity detecting circuits described above.

Since the physical quantity detection device, the physical quantity measurement system, the electronic apparatus, and the moving object described above are each configured including the physical quantity detecting circuit capable of reducing the power consumption as the whole system, the physical quantity detection device, the physical quantity measurement system, the electronic apparatus, and the moving object capable of reducing the power consumption can be realized.

### Application Example 12

A physical quantity measurement data generation method according to this application example includes generating a detection signal corresponding to a physical quantity at a first rate based on an output signal of an inertial sensor, performing arithmetic processing based on the detection signal, holding measurement data based on the detection signal, and generating and then outputting a measurement completion flag at a second rate lower than the first rate.

According to this application example, since the measurement completion flag is generated at the second rate lower than the first rate of the detection signal, the measurement data can externally be read out based on the measurement completion flag. Therefore, since the frequency of reading out the measurement data can be reduced compared to the case of reading out the measurement data at the first rate, the physical quantity measurement data generation method capable of reducing the power consumption as the whole system can be realized. Further, since the detection signal at the first rate higher than the second rate can be used in the arithmetic processing in the performing of arithmetic processing, the arithmetic processing high in accuracy becomes possible.

### BRIEF DESCRIPTION OF THE DRAWINGS

The invention will be described with reference to the accompanying drawings, wherein like numbers reference like elements.

FIG. 1 is a circuit diagram of a physical quantity measurement system 1000 according to a first embodiment of the invention.

FIG. 2 is a circuit diagram of a physical quantity measurement system 1000a according to a second embodiment of the invention.

FIG. 3 is a flowchart showing a general outline of a physical quantity measurement data generation method according to the present embodiment.

FIG. 4 is a functional block diagram of an electronic apparatus 300 according to the present embodiment.

FIG. 5A is a diagram showing an example of an appearance of a smartphone as an example of the electronic apparatus 300, and FIG. 5B is diagram showing an arm-mounted portable device as an example of the electronic apparatus 300.

FIG. 6 is a diagram (a top view) showing an example of a moving object 400 according to the present embodiment.

### DESCRIPTION OF EXEMPLARY EMBODIMENTS

Hereinafter, some preferred embodiments of the invention will be described in detail using the accompanying drawings. The drawings used herein are for the sake of convenience of explanation. It should be noted that the embodiments described below do not unreasonably limit the contents of the invention as set forth in the appended claims. Further, all of the constituents described below are not necessarily essential elements of the invention.

### 1. Physical Quantity Detecting Circuit, Physical Quantity Detection Device, and Physical Quantity Measurement System

### 1-1. First Embodiment

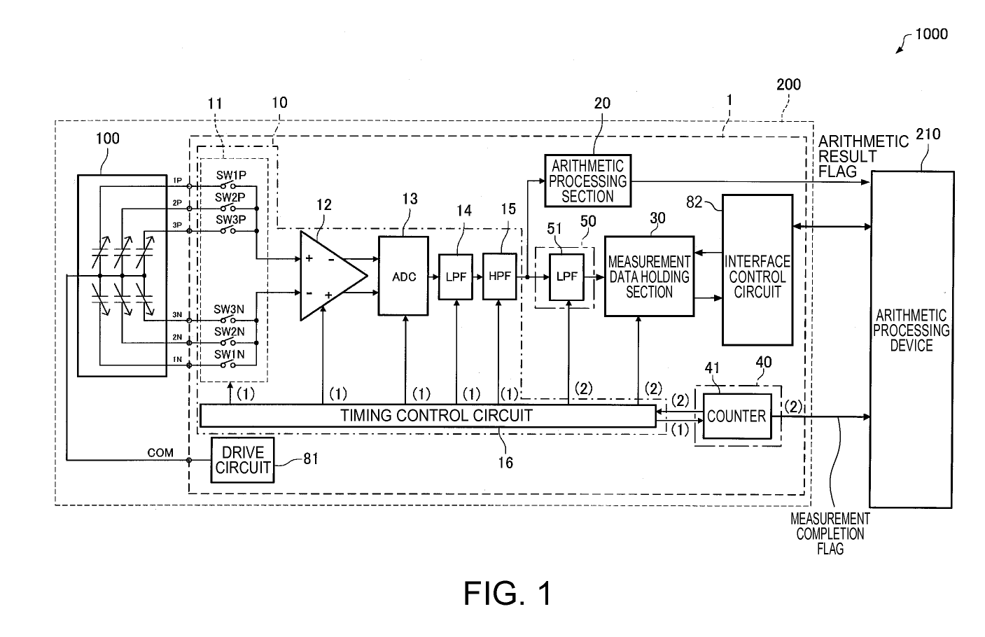

FIG. 1 is a circuit diagram of a physical quantity measurement system 1000 according to a first embodiment of the invention.

The physical quantity measurement system 1000 according to the present embodiment is configured including a physical quantity detection device 200 and an arithmetic processing device 210.

The physical quantity detection device 200 according to the present embodiment is configured including a physical quantity detecting circuit 1 and an inertial sensor 100. The physical quantity detecting circuit 1 can be formed of one semiconductor circuit or a plurality of semiconductor circuits.

The inertial sensor 100 is a sensor for detecting a physical quantity, a physical phenomenon (e.g., acceleration, a tilt angle, an impact, a vibration, and a rotation), or the like using inertia. As the inertial sensor 100, an acceleration sensor or an angular velocity sensor, for example, can be adopted. In the present embodiment, the inertial sensor 100 is formed of an acceleration sensor having the detection axes in the three directions (the X-axis direction, the Y-axis direction, and the Z-axis direction perpendicular to each other). Further, in the example shown in FIG. 1, the inertial sensor 100 is a capacitance type acceleration sensor. The inertial sensor 100 has a positive terminal and a negative terminal for each of the detection axes.

The physical quantity detecting circuit 1 according to the present embodiment is configured including a detection signal generation section 10 for generating a detection signal corresponding to the physical quantity at a first rate (1) based on an output signal of the inertial sensor 100, an arithmetic processing section 20 for performing arithmetic processing based on the detection signal, a measurement data holding section 30 for holding measurement data based on the detection signal, and a measurement completion flag generation section 40 for generating and then outputting a measurement completion flag at a second rate (2) lower than the first rate (1).

The first rate (1) can be set to, for example, 512 Hz. The second rate can be set to, for example, 32 Hz.

The detection signal generation section 10 generates the detection signal corresponding to the physical quantity at the first rate (1) based on the output signal of the inertial sensor 100.

In the example shown in FIG. 1, the detection signal generation section 10 is configured including an input multiplexer circuit 11, an amplifier circuit 12, an A/D converter 13, a low-pass filter 14, a high-pass filter 15, and a timing control circuit 16 for outputting a clock signal at the first rate (1) and a clock signal at the second rate (2).

The input multiplexer circuit 11 selects one of the detection axes of the inertial sensor 100, and then outputs the signal thereof to the amplifier circuit 12 based on the clock signal at the first rate (1) output by the timing control circuit 16. In the example shown in FIG. 1, the multiplexer circuit 11 is configured including switches SW1N, SW2N, SW3N, SW1P, SW2P, and SW3P. A first terminal of the switch SW1N is connected to an X-axis negative terminal 1N of the inertial sensor 100. A first terminal of the switch SW2N is connected to a Y-axis negative terminal 2N of the inertial sensor 100. A first terminal of the switch SW3N is connected to a Z-axis negative terminal 3N of the inertial sensor 100. A first terminal of the switch SW1P is connected to an X-axis positive terminal 1P of the inertial sensor 100. A first terminal of the switch SW2P is connected to a Y-axis positive terminal 2P of the inertial sensor 100. A first terminal of the switch SW3P is connected to a Z-axis positive terminal 3P of the inertial sensor 100. Second terminals of the switches SW1N, SW2N, and SW3N are connected to a negative input terminal of the amplifier circuit 12. Second terminals of the switches SW1P, SW2P, and SW3P are connected to a positive input terminal of the amplifier circuit 12. The input multiplexer circuit 11 sequentially switches a pair of the switches SW1N, SW1P, a pair of the switches SW2N, SW2P, and a pair of the switches SW3N, SW3P in accordance with the clock signal at the first rate (1) to thereby select one of the detection axes of the inertial sensor 100 and then output the signal thereof to the amplifier circuit 12.

The amplifier circuit 12 amplifies the output signal of the input multiplexer circuit 11, and then outputs the result to the A/D converter 13 based on the clock signal at the first rate (1) output by the timing control circuit 16. The amplifier circuit 12 can be configured including, for example, a charge amplifier and a power amplifier.

The A/D converter 13 performs the analog-to-digital conversion on the output signal of the amplifier 12, and then outputs the result to the low-pass filter 14 based on the clock signal at the first rate (1) output by the timing control circuit 16.

The low-pass filter 14 performs the low-pass filter treatment on the output signal of the A/D converter 13, and then outputs the result to the high-pass filter 15 based on the clock signal at the first rate (1) output by the timing control circuit 16.

The high-pass filter 15 performs the high-pass filter treatment on the output signal of the low-pass filter 14 based on the clock signal at the first rate (1) output by the timing control circuit 16, and then outputs the detection signal corresponding to the physical quantity (the acceleration in the present embodiment) based on the output of the inertial sensor 100.

The timing control circuit 16 generates and outputs the clock signal at the first rate (1) and the clock signal at the second rate (2).

The arithmetic processing section 20 performs the arithmetic processing based on the detection signal output by the detection signal generation section 10. The arithmetic processing performed by the arithmetic processing section 20 can be, for example, tap detection processing for detecting the presence or absence of a tap input. The tap input corresponds to an action of tapping a specific apparatus once with an input device such as a part of a human body or a stylus pen. The arithmetic processing section 20 outputs an arithmetic result flag to the arithmetic processing device 210 in accordance with the result of the arithmetic processing. For example, it is possible for the arithmetic processing section 20 to output a high level as the arithmetic result flag in the case in which the tap input has occurred, and output a low level in the case in which no tap input has occurred.

The measurement data holding section 30 holds the measurement data based on the detection signal output by the detection signal generation section 10. In the example shown in FIG. 1, the detection signal output by the detection signal generation section 10 is input to the measurement data holding section 30 via a filter 50. The measurement data holding section 30 can also be configured including, for example, a variety of types of known registers.

The measurement completion flag generation section 40 generates and outputs the measurement completion flag at the second rate (2) lower than the first rate (1). In the present embodiment, the measurement completion flag generation section 40 is configured including a counter 41 performing counting at the first rate (1). The counter 41 counts the clock signal at the first rate (1) output by the timing control circuit 16, and then outputs the measurement completion flag when the setting value has been reached. In the present embodiment, the setting value is 16. Thus, the measurement completion flag can be output at the second rate (2) lower than the first rate (1).

The physical quantity detecting circuit 1 according to the present embodiment can also be configured further including an interface control circuit 82. The interface control circuit 82 provides an interface between the measurement data holding section 30 and the arithmetic processing device 210. As an interface between the interface control circuit 82 and the arithmetic processing device 210, there can be adopted a variety of types of known interfaces such as an inter-integrated circuit (I²C), or a serial peripheral interface (SPI).

According to the physical quantity detection circuit 1 related to the present embodiment, since the measurement completion flag is generated at the second rate (2) lower than the first rate (1) of the detection signal output by the detection signal generation section 10, it is possible to read out the measurement data from an external device (e.g., the arithmetic processing device 210) based on the measurement completion flag. Therefore, the frequency of reading out the measurement data can be reduced compared to the case of reading out the measurement data at the first rate (1). Thus, since it is possible to elongate, for example, a period in which the external arithmetic processing device 210 becomes in a halt mode (HALT mode), the physical quantity detecting circuit 1 capable of reducing the power consumption as a whole system (e.g., the physical quantity measurement system 1000) can be realized. Further, since the detection signal at the first rate (1) higher than the second rate (2) can be used in the arithmetic processing of the arithmetic processing section 20, the arithmetic processing high in accuracy becomes possible.

It is also possible for the measurement data holding section 30 to update the measurement data to be held in sync with the measurement completion flag output by the measurement completion flag generation section 40. In the example shown in FIG. 1, the measurement completion flag generation section 40 outputs the clock signal at the second rate (2) to the timing control circuit 16, and the timing control circuit 16 outputs the clock signal at the second rate (2) to the measurement data holding section 30. The measurement data holding section 30 updates the measurement data in sync with the clock signal at the second rate output by the timing control circuit 16.

By adopting such a configuration, since the amount of the measurement data read out from the external device (e.g., the arithmetic processing device 210) can be reduced, the physical quantity detecting circuit 1 capable of reducing the power consumption as the whole system (e.g., the physical quantity measurement system 1000) can be realized.

It is also possible for the physical quantity detecting circuit 1 according to the present embodiment to be configured including the filter 50 disposed between the detection signal generation section 10 and the measurement data holding section 30. In the example shown in FIG. 1, the filter 50 is configured including a low-pass filter 51.

By adopting such a configuration, the filter treatment suitable for the measurement data to be held by the measurement data holding section 30 can be performed independently of the arithmetic processing section 20. For example, by adopting a low-pass filter low in cutoff frequency than the low-pass filter 14 as the low-pass filter 51, the noise component in the high-frequency band can be removed, and therefore, the data (acceleration data in the present embodiment) low in noise can be obtained in the arithmetic processing device 210.

The physical quantity detecting circuit 1 according to the present embodiment can also be configured further including a drive circuit 81. The drive circuit 81 outputs a drive signal for driving the inertial sensor 100 to a common electrode COM of the inertial sensor 100.

The arithmetic processing device 210 reads out the measurement data held by the measurement data holding section 30 based on the measurement completion flag output by the physical quantity detecting circuit 1. In other words, the arithmetic processing device 210 reads out the measurement data at the second rate (2). In the example shown in FIG. 1, the arithmetic processing device 210 reads out the measurement data held by the measurement data holding section 30 via the interface control circuit 82. The arithmetic processing device 210 can also be configured including, for example, a central processing unit (CPU). The arithmetic processing device 210 performs a variety of types of arithmetic processings based on the measurement data thus read out. For example, in the case in which the physical quantity measurement system 1000 is provided to a portable device, and the measurement data thus read out is the acceleration data, it is also possible to measure the walking of the user using the arithmetic processing. The frequency of the vibration in the walking of the user is low compared to the frequency of the vibration in the tap input described above. Therefore, in the present embodiment, the detection signal at the first rate (1) is used in the arithmetic processing using the arithmetic processing section 20, and the measurement data at the second rate (2) is used in the arithmetic processing using the arithmetic processing device 210.

As described above, since the physical quantity detection device 200 and the physical quantity measurement system 1000 according to the present embodiment are each configured including the physical quantity detecting circuit 1 capable of reducing the power consumption as the whole system, the physical quantity detection device 200 and the physical quantity measurement system 1000 each capable of reducing the power consumption can be realized.

### 1-2. Second Embodiment

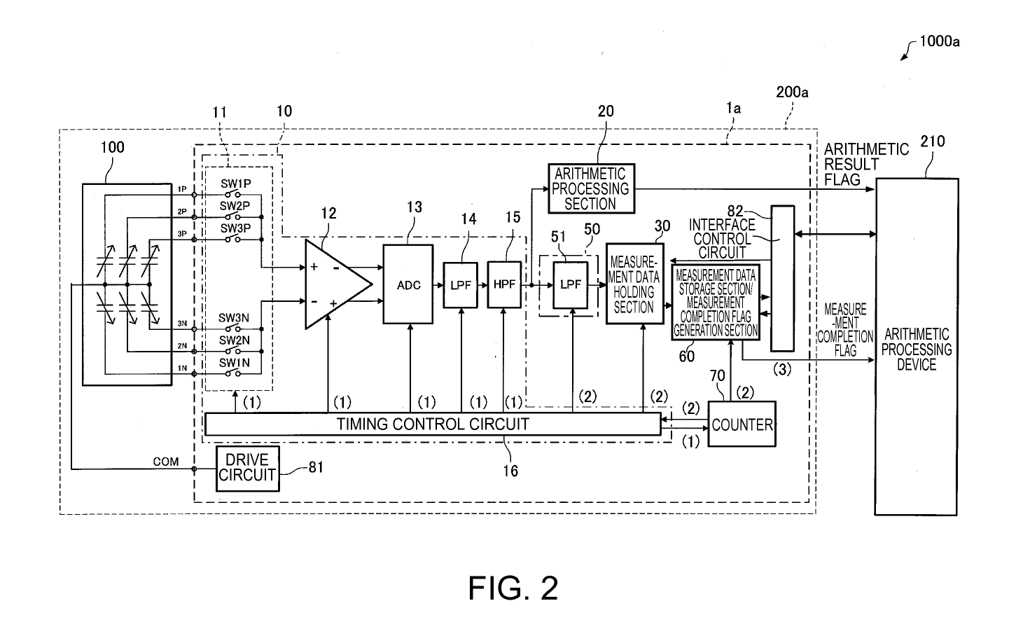

FIG. 2 is a circuit diagram of a physical quantity measurement system 1000a according to a second embodiment of the invention. The constituents similar to those of the physical quantity measurement system 1000 according to the first embodiment shown in FIG. 1 are denoted with the same reference symbols, and the detailed explanation thereof will be omitted.

The physical quantity measurement system 1000a is configured including a physical quantity detection device 200a and the arithmetic processing device 210.

The physical quantity detection device 200a is configured including a physical quantity detecting circuit 1a and the inertial sensor 100.

The physical quantity detecting circuit 1a is configured including the detection signal generation section 10, the arithmetic processing section 20, the measurement data holding section 30, and a measurement data storage section/measurement completion flag generation section 60 for storing the measurement data held by the measurement data holding section 30 sequentially up to a set number. The measurement data holding section 30 holds the measurement data at the second rate (2).

The measurement data storage section/measurement completion flag generation section 60 generates and then outputs the measurement completion flag in the case in which the measurement data holding section 30 has stored the measurement data up to the set number. The measurement data storage section/measurement completion flag generation section 60 can also be configured including, for example, a FIFO (first in, first out) circuit. In the present embodiment, the set number is 32. Therefore, the measurement data storage section/measurement completion flag generation section 60 outputs the measurement completion flag to the arithmetic processing device 210 at 1 Hz (a third rate (3)).

According to the physical quantity detecting circuit 1a related to the present embodiment, since the frequency of reading out the measurement data can be reduced compared to the case of reading out the measurement data from the external device (e.g., the arithmetic processing device 210) at the first rate (1), the physical quantity detecting circuit 1a capable of reducing the power consumption as the whole system (e.g., the physical quantity measurement system 1000) can be realized.

It is also possible that the physical quantity detecting circuit 1a according to the present embodiment includes a counter 70 for performing counting at the first rate (1), and the measurement data storage section/measurement completion flag generation section 60 updates the measurement data to be stored in sync with the timing at which the counter 70 reaches a set value. In the present embodiment, the counter 70 counts the clock signal at the first rate (1) output from the timing control circuit 16, and then outputs the clock signal at the second rate (2) to the timing control circuit 16 and the measurement data storage section/measurement completion flag generation section 60 at the timing at which the set value is reached. The measurement data storage section/measurement completion flag generation section 60 updates the measurement data to be stored in sync with the clock signal at the second rate (2) output by the counter 70.

By adopting such a configuration, since the amount of the measurement data read out from the external device (e.g., the arithmetic processing device 210) can be reduced, the physical quantity detecting circuit 1a capable of reducing the power consumption as the whole system (e.g., the physical quantity measurement system 1000a) can be realized.

Further, also in the physical quantity detecting circuit 1a, the physical quantity detection device 200a, and the physical quantity measurement system 1000a according to the second embodiment, substantially the same advantage can be obtained on substantially the same grounds as in the physical quantity detecting circuit 1, the physical quantity detection device 200, and the physical quantity measurement system 1000 according to the first embodiment.

### 2. Physical Quantity Measurement Data Generation Method

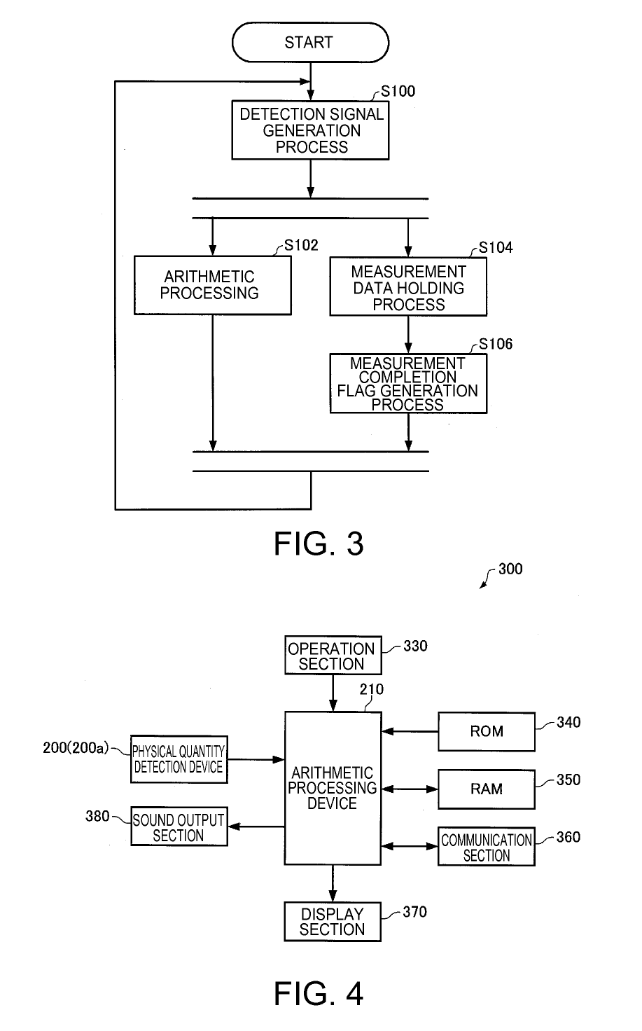

FIG. 3 is a flowchart showing a general outline of a physical quantity measurement data generation method according to the present embodiment.

The physical quantity measurement data generation method according to the present embodiment includes a detection signal generation process for generating a detection signal corresponding to the physical quantity at the first rate (1) based on the output signal of the inertial sensor 100, an arithmetic processing process for performing the arithmetic processing based on the detection signal generated in the detection signal generation process, a measurement data holding process for holding the measurement data based on the detection signal generated in the detection signal generation process, and a measurement completion flag generation process for generating and then outputting the measurement completion flag at the second rate (2) lower than the first rate (1).

Hereinafter, the case of performing the physical quantity measurement data generation method according to the present embodiment using the physical quantity detecting circuit 1 or the physical quantity detecting circuit 1a described above will be explained as an example.

Firstly, the detection signal generation section 10 performs (step S100) the detection signal generation process for generating the detection signal corresponding to the physical quantity at the first rate (1) based on the output signal of the inertial sensor 100.

Subsequently to the step S100, the arithmetic processing section 20 performs (step S102) the arithmetic processing process for performing the arithmetic processing based on the detection signal generated in the detection signal generation process in the step S100. In parallel to the step S102, and after the step S100, the measurement data holding section 30 holds (step S104) the measurement data based on the detection signal generated in the step S100.

Subsequently to the steps S102, S104, the process returns to the step S100, and then the same processes are repeated.

According to the physical quantity detection data generation method related to the present embodiment, since the measurement completion flag is generated at the second rate (2) lower than the first rate (1) of the detection signal output in the detection signal generation process, it is possible to read out the measurement data from the external device (e.g., the arithmetic processing device 210) based on the measurement completion flag. Therefore, the frequency of reading out the measurement data can be reduced compared to the case of reading out the measurement data at the first rate (1). Thus, since it is possible to elongate, for example, the period in which the external arithmetic processing device 210 becomes in the halt mode (HALT mode), the physical quantity measurement data generation method capable of reducing the power consumption as the whole system (e.g., the physical quantity measurement system 1000) can be realized. Further, since the detection signal at the first rate (1) higher than the second rate (2) can be used in the arithmetic processing of the arithmetic processing process, the arithmetic processing high inaccuracy becomes possible.

### 3. Electronic Apparatus

FIG. 4 is a functional block diagram of an electronic apparatus 300 according to the present embodiment. It should be noted that the constituents substantially the same as those of the embodiments described above are denoted with the same reference symbols, and the detailed description thereof will be omitted.

The electronic apparatus 300 according to the present embodiment is an electronic apparatus 300 including the physical quantity detecting circuit 1 or the physical quantity detecting circuit 1a. In the example shown in FIG. 4, the electronic apparatus 300 is configured including the physical quantity detection device 200 configured including the physical quantity detecting circuit 1, the arithmetic processing device 210, an operation section 330, a read only memory (ROM) 340, a random access memory (RAM) 350, a communication section 360, a display section 370, and a sound output section 380. It should be noted that the electronic apparatus 300 according to the present embodiment can also have a configuration obtained by eliminating or modifying some of the constituents (the sections) shown in FIG. 4, or adding another constituent.

The arithmetic processing device 210 performs a variety of calculation processes and control processes in accordance with programs stored in the ROM 340 and so on. Specifically, the arithmetic processing device 210 performs a variety of processes corresponding to the output signal of the physical quantity detection device 200 and the operation signal from the operation section 330, a process of controlling the communication section 360 for performing data communication with external devices, a process of transmitting a display signal for making the display section 370 display a variety of types of information, a process of making the sound output section 380 output a variety of sounds, and so on.

The operation section 330 is an input device including operation keys, button switches, and so on, and outputs the operation signal corresponding to the operation by the user to the arithmetic processing device 210.

The ROM 340 stores the programs, data, and so on for the arithmetic processing device 210 to perform the variety of calculation processes and the control processes.

The RAM 350 is used as a working area of the arithmetic processing device 210, and temporarily stores, for example, the program and data retrieved from the ROM 340, the data input from the operation section 330, and the arithmetic result obtained by the arithmetic processing device 210 performing operations in accordance with the various programs.

The communication section 360 performs a variety of control processes for achieving the data communication between the arithmetic processing device 210 and the external devices.

The display section 370 is a display device formed of a liquid crystal display (LCD), an electrophoretic display, or the like, and displays a variety of types of information based on the display signal input from the arithmetic processing device 210.

Further, the sound output section 380 is a device, such as a speaker, for outputting sounds.

According to the electronic apparatus 300 related to the present embodiment, since there is adopted the configuration including the physical quantity detecting circuit 1 capable of reducing the power consumption as the whole system, the electronic apparatus 300 capable of reducing the power consumption can be realized. It should be noted that even in the case in which the electronic apparatus 300 is configured including the physical quantity detection device 200a, which is configured including the physical quantity detecting circuit 1a, instead of the physical quantity detection device 200, substantially the same advantage can be obtained.

As the electronic apparatus 300, a variety of types of electronic apparatus can be adopted. There can be cited, for example, a personal computer (e.g., a mobile type personal computer, a laptop personal computer, and a tablet personal computer), a mobile terminal such as a cellular phone, a digital still camera, an inkjet ejection device (e.g., an inkjet printer), a storage area network apparatus such as a router or a switch, a local area network apparatus, a mobile communication base station apparatus, a television set, a video camera, a video recorder, a car navigation system, a pager, a personal digital assistance (including one having a communication function), an electronic dictionary, an electronic calculator, an electronic game machine, a gaming controller, a word processor, a workstation, a picture phone, a security television monitor, an electronic binoculars, a POS (point-of-sale) terminal, a medical instrument (e.g., an electronic thermometer, a blood pressure monitor, a blood glucose monitor, an electrocardiograph, ultrasonic diagnostic equipment, and an electronic endoscope), a fish finder, a variety of measuring instruments, gauges (e.g., gauges for cars, aircrafts, and boats and ships), a flight simulator, a head-mount display, a motion tracer, a motion tracker, a motion controller, and a pedestrian dead reckoning (PDR) system.

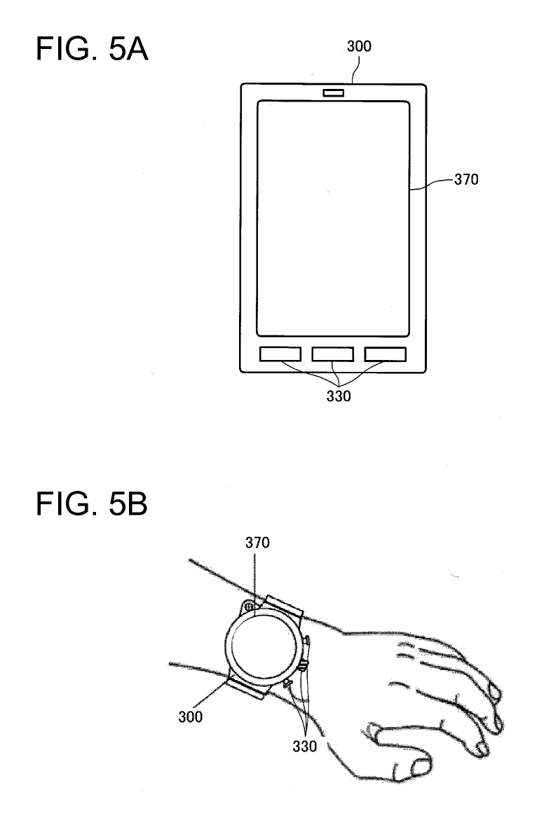

FIG. 5A is a diagram showing an example of an appearance of a smartphone as an example of the electronic apparatus 300, and FIG. 5B shows an arm-mounted portable device as an example of the electronic apparatus 300. The smartphone as the electronic apparatus 300 shown in FIG. 5A is provided with buttons as the operation section 330, and an LCD as the display section 370. The portable device as the electronic apparatus 300 shown in FIG. 5B is provided with buttons and a stem as the operation section 330, and an LCD as the display section 370. Since these electronic apparatuses 300 are each configured including the physical quantity detecting circuit 1 or the physical quantity detecting circuit 1a capable of reducing the power consumption as the whole system, the electronic apparatuses 300 capable of reducing the power consumption can be realized.

### 4. Moving Object

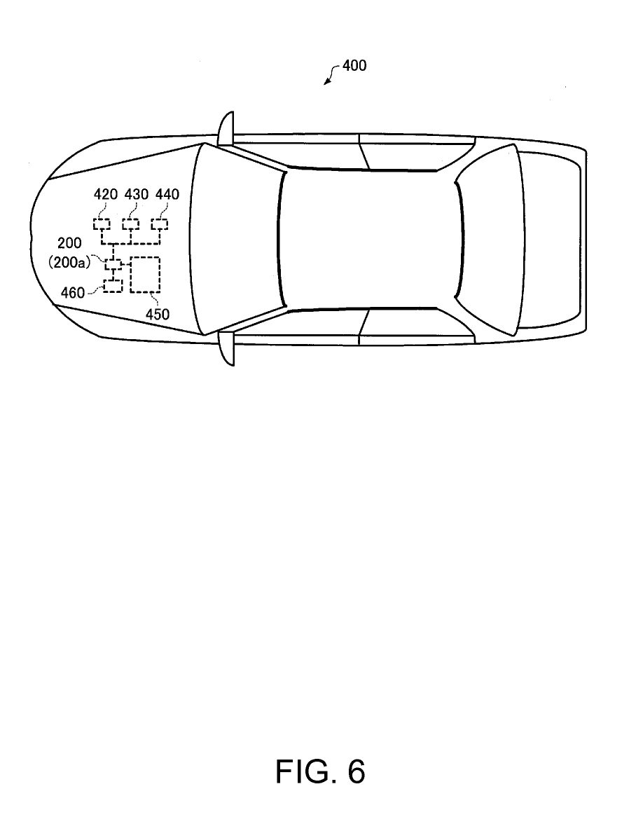

FIG. 6 is a diagram (a top view) showing an example of a moving object 400 according to the present embodiment. It should be noted that the constituents substantially the same as those of the embodiments described above are denoted with the same reference symbols, and the detailed description thereof will be omitted.

The moving object 400 according to the present embodiment is a moving object 400 including the physical quantity detecting circuit 1 or the physical quantity detecting circuit 1a. FIG. 6 shows the moving object 400 configured including the physical quantity detection device 200 configured including the physical quantity detecting circuit 1. Further, in the example shown in FIG. 6, the moving object 400 is configured including controllers 420, 430, and 440 for performing control of a variety of systems such as an engine system, a brake system, and a keyless entry system, a battery 450, and a backup battery 460. It should be noted that the moving object 400 according to the present embodiment can also have a configuration obtained by eliminating or modifying some of the constituents (the sections) shown in FIG. 6, or adding another constituent.

According to the moving object 400 related to the present embodiment, since there is included the physical quantity detecting circuit 1 capable of reducing the power consumption as the whole system, the moving object 400 capable of reducing the power consumption can be realized. It should be noted that even in the case in which the moving object 400 is configured including the physical quantity detection device 200a, which is configured including the physical quantity detecting circuit 1a, instead of the physical quantity detection device 200, substantially the same advantage can be obtained.

As such a moving object 400, a variety of types of moving objects can be adopted, and a vehicle (including an electric vehicle), an aircraft such a jet plane or a helicopter, a ship, a rocket, an artificial satellite, and so on can be cited.

Although the embodiments and the modified examples are explained hereinabove, the invention is not limited to the embodiments and the modified examples described above, but can be put into practice in various forms within the scope or the spirit of the invention.

The invention includes configurations (e.g., configurations having the same function, the same way, and the same result, or configurations having the same object and the same advantages) substantially the same as those explained in the description of the embodiments. Further, the invention includes configurations obtained by replacing a non-essential part of the configuration explained in the above description of the embodiments. Further, the invention includes configurations providing the same functions and the same advantage, or configurations capable of achieving the same object, as the configuration explained in the description of the embodiments. Further, the invention includes configurations obtained by adding a known technology to the configuration explained in the description of the embodiments.

The entire disclosure of Japanese Patent Application No. 2014-085775, filed Apr. 17, 2014 is expressly incorporated by reference herein.

What is claimed is:

1. A physical quantity detecting circuit comprising:
a detection signal generation section adapted to generate a detection signal corresponding to a physical quantity at a first rate based on an output signal of an inertial sensor;
an arithmetic processing section adapted to perform arithmetic processing based on the detection signal;
a measurement data holding section adapted to hold measurement data based on the detection signal; and
a measurement completion flag generation section adapted to generate and then output a measurement completion flag at a second rate lower than the first rate.

2. The physical quantity detecting circuit according to claim 1, wherein
the measurement completion flag generation section includes a counter adapted to perform counting at the first rate, and outputs the measurement completion flag when the counter reaches a set value.

3. The physical quantity detecting circuit according to claim 1, wherein
the measurement data holding section updates the measurement data to be held in sync with the measurement completion flag.

4. The physical quantity detecting circuit according to claim 1, further comprising:
a measurement data storage section adapted to store the measurement data, which is held by the measurement data holding section, sequentially up to a set number,
wherein the measurement data holding section holds the measurement data at the second rate, and
the measurement completion flag generation section generates and then outputs the measurement completion flag in a case in which the measurement data holding section has stored the measurement data up to the set number.

5. The physical quantity detecting circuit according to claim 4, further comprising:
a counter adapted to perform counting at the first rate,
wherein the measurement data storage section updates the measurement data to be stored in sync with a timing at which the counter reaches a set value.

6. The physical quantity detecting circuit according to claim 1, further comprising:
a filter disposed between the detection signal generation section and the measurement data holding section.

7. The physical quantity detecting circuit according to claim 1, wherein
the arithmetic processing is a tap detection processing adapted to detect one of presence and absence of a tap input.

8. A physical quantity detection device comprising:
the physical quantity detecting circuit according to claim 1; and
the inertial sensor.

9. A physical quantity detection device comprising:
the physical quantity detecting circuit according to claim 2; and
the inertial sensor.

10. A physical quantity detection device comprising:
the physical quantity detecting circuit according to claim 3; and
the inertial sensor.

11. A physical quantity detection device comprising:
the physical quantity detecting circuit according to claim 4; and
the inertial sensor.

12. A physical quantity measurement system comprising:
the physical quantity detection device according to claim 8; and
an arithmetic processing device adapted to readout the measurement data based on the measurement completion flag.

13. An electronic apparatus comprising:
the physical quantity detecting circuit according to claim 1.

14. An electronic apparatus comprising:
the physical quantity detecting circuit according to claim 2.

15. An electronic apparatus comprising:
the physical quantity detecting circuit according to claim 3.

16. An electronic apparatus comprising:
the physical quantity detecting circuit according to claim 4.

17. A moving object comprising:
the physical quantity detecting circuit according to claim 1.

18. A moving object comprising:
the physical quantity detecting circuit according to claim 2.

19. A moving object comprising:
the physical quantity detecting circuit according to claim 3.

20. A physical quantity measurement data generation method comprising:
generating a detection signal corresponding to a physical quantity at a first rate based on an output signal of an inertial sensor;
performing arithmetic processing based on the detection signal;
holding measurement data based on the detection signal; and
generating and then outputting a measurement completion flag at a second rate lower than the first rate.
